(19) United States
(12) Patent Application Publication
(10) Pub. No.: US 2025/0322009 A1
(43) Pub. Date: Oct. 16, 2025

(54) MULTIMODAL INFORMATION INTERACTION METHOD, INTELLIGENT AGENT, DEVICE AND MEDIUM

(71) Applicant: BEIJING BAIDU NETCOM SCIENCE TECHNOLOGY CO., LTD., Beijing (CN)

(72) Inventors: Zhiqiang SHU, Beijing (CN); Yugang KE, Beijing (CN); Hongbai DONG, Beijing (CN)

(21) Appl. No.: 19/246,354

(22) Filed: Jun. 23, 2025

(30) Foreign Application Priority Data
Feb. 24, 2025 (CN) 202510209041.X

(51) Int. Cl. G06F 16/43; G06F 40/30; G06T 11/00

(52) U.S. Cl. CPC G06F 16/43; G06F 40/30; G06T 11/00

(57) ABSTRACT

A multimodal information interaction method, an intelligent agent, an electronic device, and a storage medium are provided, which relate to a field of artificial intelligence technology, and in particular, to fields of large model and human-computer interaction technology. The method includes: performing intention recognition on a media resource request from a terminal to obtain an intention recognition result, where the intention recognition result represents whether the media resource request hits a predetermined processing mode; in response to the media resource request hitting the predetermined processing mode, determining a media resource address corresponding to the media resource request; and rendering a media resource in the media resource address, and outputting the rendered media stream to the terminal.

### CROSS-REFERENCE TO RELATED APPLICATION(S)

This application claims the benefit of Chinese Patent Application No. 202510209041.X filed on Feb. 24, 2025, the whole disclosure of which is incorporated herein by reference.

### TECHNICAL FIELD

The present disclosure relates to a field of artificial intelligence technology, and in particular, to fields of large model and human-computer interaction technology. More specifically, the present disclosure provides a multimodal information interaction method, an intelligent agent, an electronic device, and a storage medium.

### BACKGROUND

With the gradual popularization of the application of large models and intelligent agents, people's demand for multimodal interaction of intelligent agents is becoming stronger and stronger. However, at present, intelligent agents generally use the interaction mode of voice and text, and other media formats are output by providing links.

### SUMMARY

The present disclosure provides a multimodal information interaction method, an intelligent agent, an electronic device, and a storage medium.

According to an aspect, there is provided a multimodal information interaction method, including: performing intention recognition on a media resource request from a terminal to obtain an intention recognition result, where the intention recognition result represents whether the media resource request hits a predetermined processing mode; calling, in response to the media resource request hitting the predetermined processing mode, a first multimodal processing module to determine a media resource address corresponding to the media resource request; and calling a second multimodal processing module to render a media resource in the media resource address, and outputting the rendered media stream to the terminal.

According to another aspect, there is provided an intelligent agent configured to perform the multimodal information interaction method described above.

According to another aspect, there is provided an electronic device, including: at least one processor; and a memory communicatively connected to the at least one processor, where the memory stores instructions executable by the at least one processor, and the instructions, when executed by the at least one processor, cause the at least one processor to perform the method provided according to the present disclosure.

According to another aspect, there is provided a non-transitory computer-readable storage medium having computer instructions therein, where the computer instructions are configured to cause the computer to perform the method provided according to the present disclosure.

It should be understood that content described in this section is not intended to identify key or important features in embodiments of the present disclosure, nor is it intended to limit the scope of the present disclosure. Other features of the present disclosure will be readily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an exemplary system architecture to which a multimodal information interaction method and an apparatus may be applied according to an embodiment of the present disclosure;

FIG. 2 shows a flowchart of a multimodal information interaction method according to an embodiment of the present disclosure;

FIG. 3 shows a schematic diagram of a system to which a multimodal information interaction method may be applied according to an embodiment of the present disclosure;

FIG. 4 shows a schematic diagram of a first multimodal processing module according to an embodiment of the present disclosure;

FIG. 5 shows a schematic diagram of a second multimodal processing module according to an embodiment of the present disclosure;

FIG. 6 shows a flowchart of a multimodal information interaction method according to another embodiment of the present disclosure;

FIG. 7 shows a block diagram of a multimodal information interaction apparatus according to an embodiment of the present disclosure; and

FIG. 8 shows a block diagram of an electronic device of a multimodal information interaction method according to an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

With the gradual popularization of the application of large models and intelligent agents, people's demand for multimodal interaction of intelligent agents is becoming stronger and stronger. It is hoped that the intelligent agent directly outputs a multimodal content (a picture, a video, an audio, a web page, a document, a map) according to the user's request, and presents it directly. For example, if the user inputs “please play a song of a certain singer”, “please play the movie XXX”, “please open my XX summary slide presentation”, the corresponding media content will be played directly on the user terminal, instead of presenting some text description or media link information.

However, at present, the intelligent agent interaction mode of basic voice and text is commonly used by the intelligent agent. The intelligent agent recognizes the voice input by the user, outputs the text after processing by the large model, or outputs the voice after converting the text to the voice, and returns it to the user end. This intelligent agent only supports the output of text and audio formats, and other media formats are output by providing links.

The current intelligent agent interaction mode needs to realize the rendering of various media formats on the user end, or call other tools to open the media on the user end. This requires the user to make multiple jumps, affecting the continuous interaction experience. In addition, the user end needs to integrate a variety of media tool plug-ins, which greatly increases the volume of the user end SDK (Software Development Kit), which is not friendly to user access, especially in the browser and applet access scenarios, and increases the user access cost.

The collection, storage, use, processing, transmission, provision and disclosure of the user's personal information involved in the technical solution of the present disclosure comply with the provisions of relevant laws and regulations, and do not violate public order and good customs.

In the technical solution of the present disclosure, the authorization or consent of the user is obtained before obtaining or collecting the user's personal information.

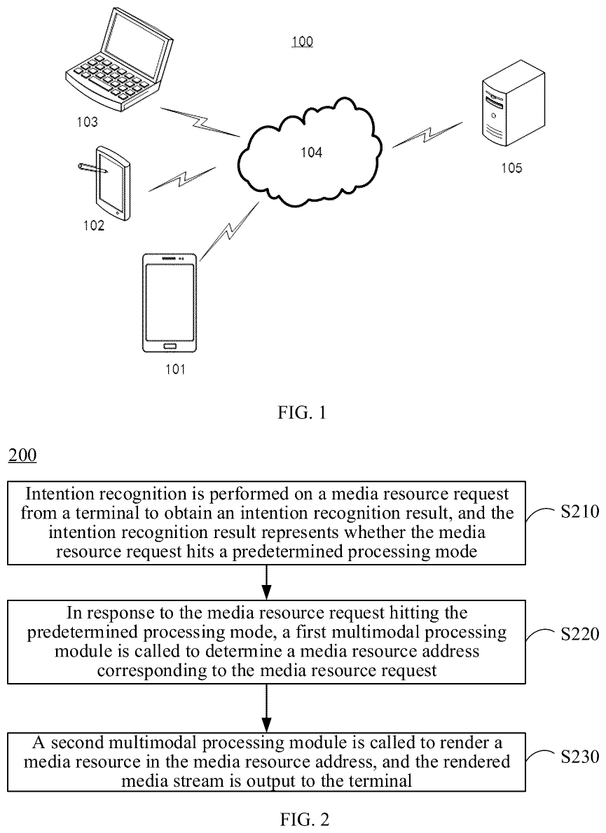

FIG. 1 shows a schematic diagram of an exemplary system architecture to which a multimodal information interaction method and an apparatus may be applied according to an embodiment of the present disclosure. It should be noted that FIG. 1 is merely an example of a system architecture that may be applied to the embodiments of the present disclosure, in order to help those skilled in the art understand the technical content of the present disclosure. However, it does not mean that the embodiments of the present disclosure may not be used for other devices, systems, environments, or scenarios.

As shown in FIG. 1, a system architecture 100 according to the embodiment may include terminal devices 101, 102, 103, a network 104, and a server 105. The network 104 is a medium for providing a communication link between the terminal devices 101, 102, 103 and the server 105. The network 104 may include various connection types, such as wired and/or wireless communication links, and the like.

A user may use the terminal devices 101, 102, 103 to interact with the server 105 through the network 104 to receive or send a message, or the like. The terminal devices 101, 102, 103 may be various electronic devices, including but not limited to a smart phone, a tablet, a laptop, and the like.

The server 105 may be a server that provides various services, such as a background management server (only an example) that provides support for a website browsed by the user using the terminal devices 101, 102, 103. The background management server may analyze and process the received data such as a user request, and feed back the processing results to the terminal device.

The multimodal information interaction method provided by the embodiments of the present disclosure may generally be performed by the server 105. Accordingly, the multimodal information interaction apparatus provided by the embodiments of the present disclosure may generally be provided in the server 105.

FIG. 2 shows a flowchart of a multimodal information interaction method according to an embodiment of the present disclosure.

As shown in FIG. 2, a multimodal information interaction method 200 includes operation S210 to operation S230.

An execution subject in the embodiment may be an intelligent agent, and the intelligent agent may be integrated with a large language model.

In operation S210, intention recognition is performed on a media resource request from a terminal to obtain an intention recognition result, and the intention recognition result represents whether the media resource request hits a predetermined processing mode.

After receiving the user's media resource request sent by the terminal, the intelligent agent may analyze and understand the media resource request through the large language model in the intelligent agent to recognize the user's intention. The intention recognition result of the user may include whether the user's media resource request hits the predetermined processing mode. The predetermined processing mode may be a mode that needs to render the media resource requested by the user in the cloud.

For example, the user's media resource request is “play a funny video for me”, and the large language model in the intelligent agent may perform the intention recognition on the request, and may determine that what the user needs the intelligent agent to return is “play a funny video”, that is, it is not provided in the form of a link, but directly play the video content in the form of a video stream. Therefore, according to the intention recognition result, it may be determined that the user's media resource request hit the predetermined processing mode, that is, the media resource requested by the user needs to be rendered in the cloud and returned to the terminal in the form of video stream.

In operation S220, in response to the media resource request hitting the predetermined processing mode, a first multimodal processing module is called to determine a media resource address corresponding to the media resource request.

After determining that the media resource request hits the predetermined processing mode, the intelligent agent may call the first multimodal processing module to determine the address of the media resource to be requested by the media resource request.

For example, the first multimodal processing module may include a search module, and the search module may search according to the media resource request to obtain the media resource and the media resource address corresponding to the media resource request. For example, it is possible to search and get one or more “funny videos” and the address links of “funny videos”.

In operation S230, a second multimodal processing module is called to render a media resource in the media resource address, and the rendered media stream is output to the terminal.

After determining the media resource address corresponding to the media resource request, the first multimodal processing module may return the media resource address to the intelligent agent, and the intelligent agent may send the media resource address to the second multimodal processing module.

The second multimodal processing module may be a module for cloud rendering the media resource. After receiving the media resource address, the second multimodal processing module may acquire the media resource based on the media resource address, perform rendering, and then send the rendered media stream to the terminal.

According to the embodiments of the present disclosure, the intention recognition is performed on the media resource request from the terminal to determine whether the media resource request hits the predetermined processing mode. When the predetermined processing mode is hit, the first multimodal processing module is called to determine the media resource address corresponding to the media resource request, the second multimodal processing module is called to render the media resource in the multimedia resource address, and the rendered media stream is sent to the terminal. Because the media resource may be output to the terminal in the form of media stream, the user may intuitively obtain the media content, which may improve the interaction experience.

Compared with the way in the related art that the media needs to be rendered on the terminal side, or the terminal needs to call the media tool to open the media, the embodiments of the present disclosure may avoid multiple jumps in the interaction process and maintain the continuity of the interaction. Moreover, multimedia rendering is implemented in the cloud, which may minimize the volume of the intelligent agent application on the terminal side and reduce the user access cost.

In the embodiments of the present disclosure, media content is output in the form of media stream, and as a new interaction mode, it will not only provide more application scenarios for large model interaction applications, but also further improve the user's interaction experience.

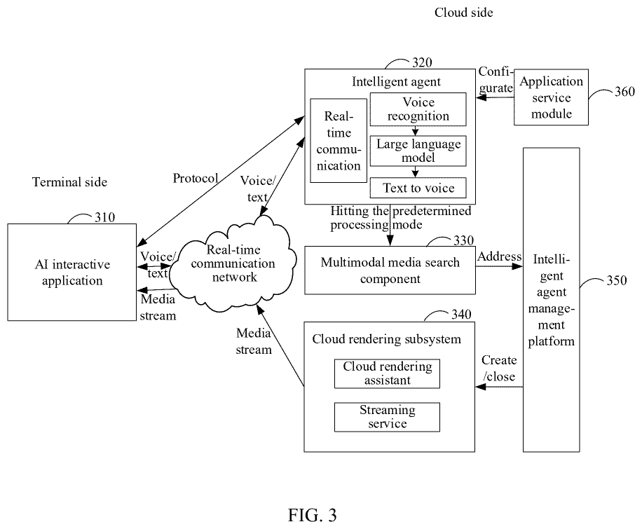

FIG. 3 shows a schematic diagram of a system to which a multimodal information interaction method may be applied according to an embodiment of the present disclosure.

As shown in FIG. 3, the system of the embodiment includes a terminal side and a cloud side, the terminal side includes an AI interaction application 310, and the cloud side includes an intelligent agent 320, a multimodal media search component 330, a cloud rendering subsystem 340, an intelligent agent management platform 350, and an application service module 360. The multimodal media search component 330 may be the first multimodal processing module of the embodiments of the present disclosure, and the cloud rendering subsystem 340 may be the second multimodal processing module of the embodiments of the present disclosure.

The AI interaction application 310 is used to provide a page for the user to interact with the intelligent agent 320. By the user inputting the request on the page, the terminal may send the request to the intelligent agent 320 through a real-time communication network. A real-time communication protocol is established between the AI interaction application 310 and the intelligent agent 320.

The intelligent agent 320 may be integrated with a voice recognition module, a large language model, a text-to-voice module, and a real-time communication module. The user's request may be a media resource request. After the intelligent agent 320 receiving the user's media resource request, if the user's media resource request is voice, the intelligent agent 320 may convert the voice into the text through the voice recognition module, and then send the text to the large language model. The large language model may analyze and understand the text and determine the user's intention. If the user's intention is ordinary interaction, such as letting the large model summarize the summary of multi requested media resources, letting the large model return the link of media resources, etc., that is, the user's media resource request does not hit the predetermined processing mode, the large language model may generate reply content, and may send the reply content to the text-to-voice module, and the text-to-voice module may convert the reply information into audio, and then return it to the AI interaction application 310 through the real-time communication network.

If the user's media resource request hits the predetermined processing mode, that is, the user's intention is to have the large model return the media resource in the form of media stream, the intelligent agent 320 will call the multimodal media search component 330 for processing.

For example, the large language model recognizes the intention of “play a funny video” from the user's request, and may determine that the user's intention is to ask the intelligent agent 320 to return the played video instead of providing a link to the video. Therefore, it may be determined that the user's media resource request hits the predetermined processing mode.

For another example, if the user's media resource request contains a predetermined prefix, it may also be determined that the media resource request hits the predetermined processing mode. The predetermined prefix includes, for example, keywords such as “cloud rendering”, “cloud playing”, etc. If the user's media resource request is “cloud playing a certain movie”, the media resource request hits the predetermined processing mode.

The application service module 360 is used to configure and manage the above-mentioned predetermined processing mode. For example, the application service module 360 may configure the predetermined processing function Function Call in the intelligent agent 320 to process the media resource request that hits the predetermined processing mode. When the large language model determines that the user's media resource request hits the predetermined processing mode through the intention recognition, the intelligent agent 320 may call the function Function Call to process the media resource request, and the Function Call will call the multimodal media search component 330 for processing.

The multimodal media search component 330 may search the media resource corresponding to the media resource request, and send the address of the searched media resource to the intelligent agent management platform 350. In addition, the intention of the user's multimedia resource request may also include the processing type of the media resource request, and the processing type may include searching, generating, etc. For example, the media resource requested by the user may not be the existing media resource in the network, but need to be generated by a large model. In this case, the multimodal media search component 330 may call the multimodal large model to generate the media resource required by the user, such as generating an image, a video, a text, an audio, a document, etc. Then the generated media resource is stored and the stored address is sent to the intelligent agent management platform 350.

The intelligent agent management platform 350 is the management platform of the intelligent agent 320 and is responsible for the real-time communication between the intelligent agent 320, the multimodal media search component 330 and the cloud rendering subsystem 340. For example, after receiving the media resource address sent by the multimodal media search component 330, the intelligent agent management platform 350 may send the media resource address to the cloud rendering subsystem 340.

According to the embodiments of the present disclosure, the cloud rendering subsystem 340 is used to acquire the media resource from the media resource address, render the media resource to the virtual screen, and collect the content on the virtual screen to obtain the media stream.

The cloud rendering subsystem 340 may include a media rendering assistant and a streaming service module. The media resource address may be a media resource link. The media rendering assistant may open the link, obtain the media resource, and render the media resource. For example, the media rendering assistant may render the media resource onto a virtual screen, and the rendered media stream may be included on the virtual screen. The streaming service module may collect the content on the virtual screen to obtain the rendered media stream. Next, the streaming service module may output the collected media stream and send the media stream to the AI interaction application 310 on the terminal side through the real-time communication network.

In addition, the intelligent agent management platform 350 is also used to create and manage the cloud rendering task in the cloud rendering subsystem 340 and the intelligent agent task in the intelligent agent 320.

According to the embodiments of the present disclosure, in response to the intelligent agent call request from the terminal, the intelligent agent is started and the cloud rendering task is assigned to the second multimodal processing module; in response to the intelligent agent shutdown request from the terminal, the intelligent agent is shut down and the cloud rendering task is released.

For example, before interacting with the intelligent agent 320 based on the AI interaction application 310, the user first calls the intelligent agent to start the intelligent agent. Specifically, the intelligent agent management platform 350 starts the intelligent agent in response to the request to call the intelligent agent, and starting the intelligent agent refers to, for example, creating an intelligent agent instance. The intelligent agent instance is the intelligent agent task, and the interaction between the user and the intelligent agent is carried out in the task. After the user initiates the request to shut down the intelligent agent, the intelligent agent management platform 350 shuts down the intelligent agent instance without interaction in response to the request to shut down the intelligent agent.

After starting the intelligent agent, the intelligent agent management platform 350 may create a cloud rendering instance in advance, so that in the process of interacting with the user, after receiving the media resource request that hits the predetermined processing mode, cloud rendering may be quickly performed and the response speed may be improved. The intelligent agent management platform 350 creates a cloud rendering instance, i.e., assigning the cloud rendering task to cloud rendering subsystem 340. Specifically, after starting the intelligent agent, the intelligent agent management platform 350 pre-allocates an idle instance for the cloud rendering subsystem 340. After obtaining the media resource address, the intelligent agent management platform 350 sends the media resource address to the pre-allocated instance. The cloud rendering subsystem 340 starts the instance and performs the cloud rendering operation in the instance.

According to the embodiments of the present disclosure, the intelligent agent management platform pre-allocates the cloud rendering instance for the cloud rendering subsystem after the intelligent agent is started. After the user's media resource request hits the predetermined processing mode, the multimedia element content may be directly streamed and output to the end side through the cloud rendering instance quickly, which improves the interaction efficiency.

According to the embodiments of the present disclosure, the multimodal information interaction method further includes: receiving an interaction operation event from the terminal, wherein the interaction operation event is generated by the terminal in response to an interaction operation of a target object for the media stream on the terminal; and calling the second multimodal processing module to perform the interaction operation for the media stream on the virtual screen according to the interaction operation event, so that the terminal displays an interaction result.

After the cloud rendering subsystem sends the media stream to the terminal, the terminal may display the media stream. The user may perform the interaction operation for the media stream displayed on the terminal, such as clicking, sliding and other operations. The terminal may collect the user's clicking, sliding and other interaction operations, and generate the interaction operation event. The terminal may send the interaction operation event to the cloud rendering instance of the second multimodal processing module.

The cloud rendering instance of the second multimodal processing module may perform the interaction operations such as clicking and sliding on the media stream on the virtual screen based on the received interaction operation events, so that the media stream on the virtual screen presents interaction effects such as pausing, playing, turning pages of the played file, pulling down the output web page, and the like, and the media stream on the terminal also correspondingly presents interaction effects such as pausing, playing, turning pages of the played file, pulling down the output web page, and the like.

According to the embodiments of the present disclosure, by sending the interaction operation event to the cloud rendering instance, the cloud rendering instance performs the interaction operation on the media stream on the virtual screen, so that the media stream on the terminal presents the interaction effect, which may enable the user to interact with the intelligent agent in a deeper level and improve the user interaction experience.

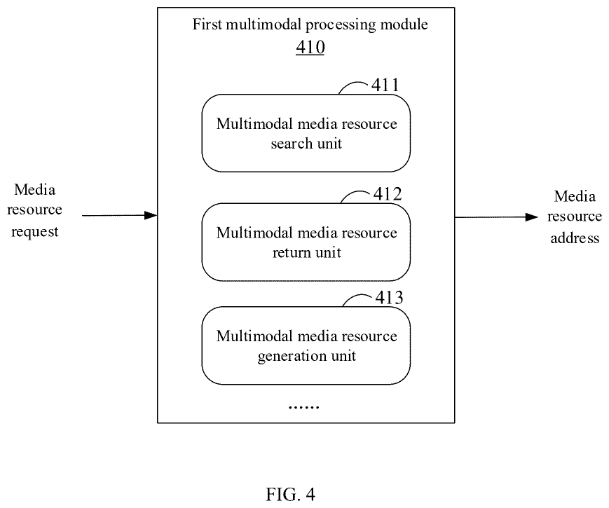

FIG. 4 shows a schematic diagram of a first multimodal processing module according to an embodiment of the present disclosure.

As shown in FIG. 4, the first multimodal processing module 410 may be the multimodal media search component described above, and may include a multimodal media resource search unit 411, a multimodal media resource return unit 412, and a multimodal media resource generation unit 413. Different units correspond to different processing types of media resource requests.

According to the embodiments of the present disclosure, the intention recognition result further represents the processing type of the media resource request; the first multimodal processing module, in response to the processing type being searching, searches the media resource corresponding to the media resource request and obtains the media resource address corresponding to the media resource request; in response to the processing type being returning, determines that a predetermined address is the media resource address corresponding to the media resource request; and in response to the processing type being generating, generates a media resource and a media resource address corresponding to the media resource request.

For example, the large language model in the intelligent agent performs intent recognition on the media resource request. The intention recognition result not only represents whether the media resource request hits the predetermined processing mode, but also represents the processing type for the media resource request when the predetermined processing mode is hit. The processing type may include searching, returning, generating, etc.

For example, if the user's intention is to search for one or more media resources, the processing type of the media resource request may be “searching”. The media resource request may contain the conditions to search for the media resource, such as name, time, keywords, etc. The multimodal media resource search unit 411 may search according to the media resource request to obtain the media resource that meets the user's needs and the address of the media resource. The multimodal media resource search unit 411 may send the searched media resource to the intelligent agent management platform.

For another example, if the user's intention is to require the intelligent agent to return a predetermined media resource, for example, the corresponding relationship between the specified intention and the predetermined media resource link is pre-configured. At this point, the multimodal media resource return unit 412 may directly send the address of the predetermined media resource to the intelligent agent management platform.

For another example, if the user's intention is to generate a customized media resource, the media resource request contains the user's customized generation information. The multimodal media resource generation unit 413 may call the multimodal large model to generate the media resource that meets the user's needs based on the customized generation information, and then store the generated media resource to obtain the media resource address. Then, the multimodal media resource generation unit 413 may send the generated media resource address to the intelligent agent management platform.

According to the embodiments of the present disclosure, the processing type of the media resource request is determined by performing intention recognition on the media resource request, and the corresponding processing is carried out for different processing types to obtain the media resource address, which may meet the diversity needs of the user and improve the user experience.

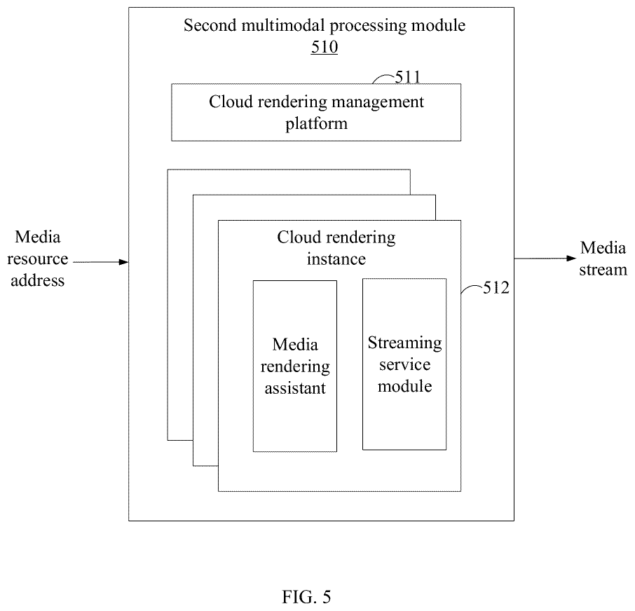

FIG. 5 shows a schematic diagram of a second multimodal processing module according to an embodiment of the present disclosure.

As shown in FIG. 5, a second multimodal processing module 510 may be a cloud rendering subsystem. The second multimodal processing module 510 may include a cloud rendering management platform 511 and a plurality of cloud rendering instances 512, and each cloud rendering instance may include a media rendering assistant and a streaming service module. The cloud rendering management platform 511 is used to communicate with the intelligent agent management platform and manage the cloud rendering instances.

For example, after the intelligent agent is started, the intelligent agent management platform may allocate one or more idle instances to the cloud rendering subsystem as the cloud rendering instance 512. The intelligent agent management platform may call up the specified cloud rendering instance in advance through the interface of the cloud rendering management platform, and may also start the media rendering assistant in advance. In this way, the cloud rendering instance 512 may quickly perform media rendering after receiving the media resource address sent by the intelligent agent management platform.

For example, the cloud rendering management platform 511 may send a command to the media rendering assistant after receiving the media resource address sent by the intelligent agent management platform, and the media rendering assistant may open the media link for media rendering and render the media resource to the virtual screen. The streaming service module collects the media stream on the virtual screen and pushes the media stream to the user end.

There may be one or more media resource addresses sent by the intelligent agent management platform, and when there are a plurality of media resource addresses, the media rendering assistant may open and render in sequence according to the list of media resource addresses.

According to the embodiments of the present disclosure, by rendering the media resource in the media resource address, and collecting the rendered media stream and pushing it to the terminal, the user may intuitively obtain the content of media resource, and the interaction experience may be improved.

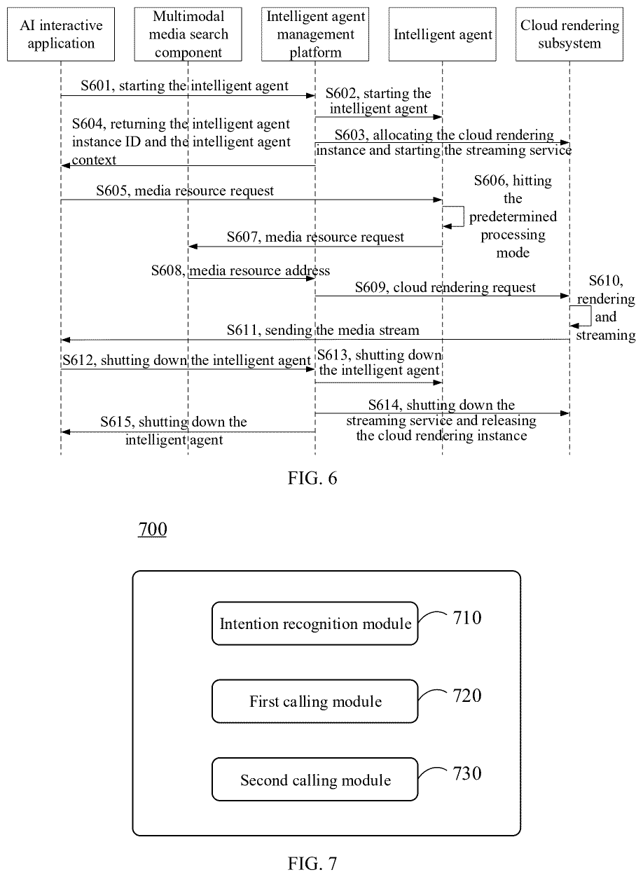

FIG. 6 shows a flowchart of a multimodal information interaction method according to another embodiment of the present disclosure.

As shown in FIG. 6, the embodiment includes operation S601 to operation S615.

In operation S601, the terminal sends a request to start the intelligent agent to the intelligent agent management platform through the AI interaction application.

In operation S602, the intelligent agent management platform starts the intelligent agent; starting the intelligent agent refers to, for example, creating an intelligent agent instance.

In operation S603, the intelligent agent management platform allocates the cloud rendering instance to the cloud rendering subsystem and starts the streaming service, such as starting the media rendering assistant in the cloud rendering subsystem.

In operation S604, the intelligent agent management platform returns the intelligent agent instance ID and the intelligent agent context to the AI interaction application.

In operation S605, the user sends the media resource request to the intelligent agent management platform through the AI interaction application.

In operation S606, the intelligent agent performs intention recognition on the media resource request and determines whether the media resource request hits the predetermined processing mode.

In operation S607, when the media resource request hits the predetermined processing mode, the intelligent agent sends the media resource request to the multimodal media search component.

In operation S608, the multimodal media search component searches out the media resource address according to the media resource request and sends the media resource address to the intelligent agent management platform.

In operation S609, the intelligent agent management platform sends the cloud rendering request to the cloud rendering subsystem, where the cloud rendering request includes the media resource address.

In operation S610, the cloud rendering subsystem calls the media rendering assistant to render the media resource, and calls the streaming service to collect the rendered media stream.

In operation S611, the cloud rendering subsystem sends the rendered media stream to the AI interaction application.

In operation S612, the user sends the request to shut down the intelligent agent to the intelligent agent management platform through the AI interaction application.

In operation S613, the intelligent agent management platform shuts down the intelligent agent, for example, shuts down the intelligent agent instance.

In operation S614, the intelligent agent management platform shuts down the streaming service and releases the cloud rendering instance.

In operation S615, the intelligent agent management platform sends a notification of shutting down the intelligent agent to the AI interaction application.

According to the embodiments of the disclosure, the present disclosure further provides a multimodal information interaction apparatus.

FIG. 7 shows a block diagram of a multimodal information interaction apparatus according to an embodiment of the present disclosure.

As shown in FIG. 7, a multimodal information interaction apparatus 700 includes an intention recognition module 710, a first calling module 720, and a second calling module 730.

The intention recognition module 710 is used to perform intention recognition on the media resource request from the terminal and obtain the intention recognition result, where the intention recognition result represents whether the media resource request hits the predetermined processing mode.

The first calling module 720 is used to, in response to the received media resource request from the terminal hitting the predetermined processing mode, call the first multimodal processing module to determine the media resource address corresponding to the media resource request.

The second calling module 730 is used to call the second multimodal processing module to render the media resource in the media resource address, and output the rendered media stream to the terminal.

According to the embodiments of the present disclosure, the second calling module 730 is used to call the second multimodal processing module to perform the following operations: obtaining the media resource from the media resource address; rendering the media resource onto the virtual screen; and collecting the content on the virtual screen to obtain the media stream.

According to the embodiments of the present disclosure, the multimodal information interaction apparatus 700 further includes a receiving module and a third calling module.

The receiving module is used to receive the interaction operation event from the terminal, where the interaction operation event is generated by the terminal in response to the interaction operation of the target object for the media stream on the terminal.

The third calling module is used to call the second multimodal processing module to perform interaction operation for the media stream on the virtual screen according to the interaction operation event, so that the terminal displays the interaction result.

According to the embodiments of the present disclosure, the intention recognition result further represents the processing type of the media resource request. The first calling module 720 is used to call the second multimodal processing module to perform one of the following operations: searching, in response to the processing type being searching, the media resource corresponding to the media resource request to obtain the media resource address corresponding to the media resource request; determining, in response to the processing type being returning, the predetermined address is the media resource address corresponding to the media resource request; generating, in response to the processing type being generating, a media resource and a media resource address corresponding to the media resource request.

According to the embodiments of the present disclosure, the multimodal information interaction apparatus 700 further includes a first response module and a second response module.

The first response module is used to, in response to the intelligent agent call request from the terminal, start the intelligent agent and assign the cloud rendering task to the second multimodal processing module.

The second response module is used to, in response to the intelligent agent shutdown request from the terminal, the intelligent agent is shut down and the cloud rendering task is released.

According to the embodiments of the present disclosure, the second calling module 730 is used to call the second multimodal processing module to start the cloud rendering task to perform the operation of rendering the media resource in the media resource address.

According to the embodiments of the present disclosure, the present disclosure further provides an electronic device, a readable storage medium and a computer program product.

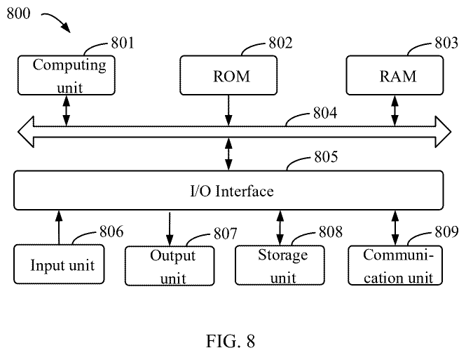

FIG. 8 shows a schematic block diagram of an exemplary electronic device 800 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data required for an operation of the device 800 may also be stored. The computing unit 801, the ROM 802 and the RAM 803 are connected to each other through a bus 804. An input/output (I/O) interface 805 is also connected to the bus 804.

A plurality of components in the device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the device 800 to exchange information/data with other devices through a computer network such as Internet and/or various telecommunication networks.

The computing unit 801 may be various general-purpose and/or dedicated processing components having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 801 executes various methods and processes described above, such as the multimodal information interaction method. For example, in some embodiments, the multimodal information interaction method may be implemented as a computer software program which is tangibly embodied in a machine-readable medium, such as the storage unit 808. In some embodiments, the computer program may be partially or entirely loaded and/or installed in the device 800 via the ROM 802 and/or the communication unit 809. The computer program, when loaded in the RAM 803 and executed by the computing unit 801, may execute one or more steps in the multimodal information interaction method described above. Alternatively, in other embodiments, the computing unit 801 may be configured to perform the multimodal information interaction method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, an user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A multimodal information interaction method, comprising:
performing intention recognition on a media resource request from a terminal to obtain an intention recognition result, wherein the intention recognition result represents whether the media resource request hits a predetermined processing mode;
in response to the media resource request hitting the predetermined processing mode, determining a media resource address corresponding to the media resource request; and
rendering a media resource in the media resource address, and outputting a rendered media stream to the terminal.

2. The method according to claim 1, wherein the rendering a media resource in the media resource address comprises:
acquiring the media resource from the media resource address;
rendering the media resource onto a virtual screen; and
collecting a content on the virtual screen to obtain a media stream.

3. The method according to claim 2, further comprising:
receiving an interaction operation event from the terminal, wherein the interaction operation event is generated by the terminal in response to an interaction operation of a target object on the media stream on the terminal; and
performing the interaction operation on the media stream on the virtual screen according to the interaction operation event, so that the terminal displays an interaction result.

4. The method according to claim 1, wherein the intention recognition result further represents a processing type of the media resource request; the in response to the media resource request hitting the predetermined processing mode, determining a media resource address corresponding to the media resource request comprises one of:
searching, in response to the processing type being searching, the media resource corresponding to the media resource request to obtain the media resource address corresponding to the media resource request;
determining, in response to the processing type being returning, a predetermined address as the media resource address corresponding to the media resource request; and
generating, in response to the processing type being generating, the media resource and the media resource address corresponding to the media resource request.

5. The method according to claim 1, further comprising:
in response to an intelligent agent call request from the terminal, starting an intelligent agent and assigning a cloud rendering task; and
in response to an intelligent agent shutdown request from the terminal, shutting down the intelligent agent and releasing the cloud rendering task.

6. The method according to claim 5, wherein the rendering a media resource in the media resource address comprises:
starting the cloud rendering task to perform an operation of rendering the media resource in the media resource address.

7. The method according to claim 1, wherein one or more media resource addresses correspond to the media resource request, and when a plurality of media resource addresses correspond to the media resource request, media resources are opened and rendered in sequence according to a list of the plurality of media resource addresses.

8. An intelligent agent, configured to perform the method according to claim 1.

9. An electronic device, comprising:
at least one processor; and
a memory communicatively connected to the at least one processor,
wherein the memory stores instructions executable by the at least one processor, and the instructions, when executed by the at least one processor, cause the at least one processor to:
perform intention recognition on a media resource request from a terminal to obtain an intention recognition result, wherein the intention recognition result represents whether the media resource request hits a predetermined processing mode;
in response to the media resource request hitting the predetermined processing mode, determine a media resource address corresponding to the media resource request; and
render a media resource in the media resource address, and output a rendered media stream to the terminal.

10. The electronic device according to claim 9, wherein the at least one processor is further configured to:
acquire the media resource from the media resource address;
render the media resource onto a virtual screen; and
collect a content on the virtual screen to obtain a media stream.

11. The electronic device according to claim 10, wherein the at least one processor is further configured to:
receive an interaction operation event from the terminal, wherein the interaction operation event is generated by the terminal in response to an interaction operation of a target object on the media stream on the terminal; and
perform the interaction operation on the media stream on the virtual screen according to the interaction operation event, so that the terminal displays an interaction result.

12. The electronic device according to claim 9, wherein the intention recognition result further represents a processing type of the media resource request; wherein the at least one processor is further configured to perform one of:
searching, in response to the processing type being searching, the media resource corresponding to the media resource request to obtain the media resource address corresponding to the media resource request;
determining, in response to the processing type being returning, a predetermined address as the media resource address corresponding to the media resource request; and
generating, in response to the processing type being generating, the media resource and the media resource address corresponding to the media resource request.

13. The electronic device according to claim 9, wherein the at least one processor is further configured to:
in response to an intelligent agent call request from the terminal, start an intelligent agent and assign a cloud rendering task; and
in response to an intelligent agent shutdown request from the terminal, shut down the intelligent agent and release the cloud rendering task.

14. The electronic device according to claim 13, wherein the at least one processor is further configured to:
start the cloud rendering task to perform an operation of rendering the media resource in the media resource address.

15. The electronic device according to claim 9, wherein one or more media resource addresses correspond to the media resource request, and when a plurality of media resource addresses correspond to the media resource request, media resources are opened and rendered in sequence according to a list of the plurality of media resource addresses.

16. A non-transitory computer-readable storage medium having computer instructions therein, wherein the computer instructions, when executed by a processor, are configured to cause the computer to:
perform intention recognition on a media resource request from a terminal to obtain an intention recognition result, wherein the intention recognition result represents whether the media resource request hits a predetermined processing mode;
in response to the media resource request hitting the predetermined processing mode, determine a media resource address corresponding to the media resource request; and
render a media resource in the media resource address, and output a rendered media stream to the terminal.

17. The non-transitory computer-readable storage medium according to claim 16, wherein the computer instructions, when executed by the processor, are further configured to cause the computer to:
acquire the media resource from the media resource address;
render the media resource onto a virtual screen; and
collect a content on the virtual screen to obtain a media stream.

18. The non-transitory computer-readable storage medium according to claim 17, wherein the computer instructions, when executed by the processor, are further configured to cause the computer to:
receive an interaction operation event from the terminal, wherein the interaction operation event is generated by the terminal in response to an interaction operation of a target object on the media stream on the terminal; and
perform the interaction operation on the media stream on the virtual screen according to the interaction operation event, so that the terminal displays an interaction result.

19. The non-transitory computer-readable storage medium according to claim 16, wherein the intention recognition result further represents a processing type of the media resource request; wherein the computer instructions, when executed by the processor, are further configured to cause the computer to perform one of:
searching, in response to the processing type being searching, the media resource corresponding to the media resource request to obtain the media resource address corresponding to the media resource request;
determining, in response to the processing type being returning, a predetermined address as the media resource address corresponding to the media resource request; and
generating, in response to the processing type being generating, the media resource and the media resource address corresponding to the media resource request.

20. The non-transitory computer-readable storage medium according to claim 16, wherein the computer instructions, when executed by the processor, are further configured to cause the computer to:
in response to an intelligent agent call request from the terminal, start an intelligent agent and assign a cloud rendering task; and
in response to an intelligent agent shutdown request from the terminal, shut down the intelligent agent and release the cloud rendering task.
